(19) United States
(12) Patent Application Publication
(10) Pub. No.: US 2009/0252298 A1
(43) Pub. Date: Oct. 8, 2009

(54) RADIATION GENERATOR

(76) Inventors: Thomas Luthardt, Bamberg (DE); Werner Odorfer, Engelthal (DE)

Correspondence Address: BRINKS HOFER GILSON & LIONE, P.O. BOX 10395, CHICAGO, IL, 60610, US

(21) Appl. No.: 12/415,325

(22) Filed: Mar. 31, 2009

(30) Foreign Application Priority Data
Apr. 3, 2008 (DE) 10 2005 049 455 B

(51) Int. Cl. H01J 35/12

(52) U.S. Cl. 378/141

(57) ABSTRACT

A radiation generator comprising a protective tube housing, cooling liquid and a radiation generating tube, wherein the radiation generating tube is disposed in the protective tube housing filled with the cooling liquid, characterized in that at least one flow channel is integrally molded on the protective tube housing for a cooling medium ducted via an inlet and outlet pipe and serving to cool the interior of the housing.

This patent document claims the benefit of DE 10 2008 017 153.0 filed Apr. 3, 2008, which is hereby incorporated by reference.

### BACKGROUND

The present embodiments relate to a radiation generator.

Ray-based imaging devices, which like X-ray equipment used for fluoroscopy or computed tomography scanners used for cross-sectional imaging, are used in the medical diagnostics field. Powerful and efficient devices have been developed in the course of ongoing technological advances. In order to generate radiation, such as X-ray beams, electrons are accelerated from a cathode to an anode and brought to an abrupt stop at the anode. As a result, X-ray radiation is generated. During the braking process, however, only a part of the electrons' energy is converted into X-ray radiation, with the majority being transformed into heat. Temperatures of several 100° C. are reached in the radiation generating tubes. Accordingly, the radiation generating tube is surrounded by cooling liquid. The higher the power output of a radiation generating tube, the greater also must be the cooling capacity of the radiation generator.

DE 10 2005 049 445 B4 describes a heat exchanger for a single-tank generator of an X-ray diagnostic device that stirs up the cooling liquid using a circulating pump and thereby effects a more efficient dissipation of the thermal energy away from the radiation generating tube.

DE 88 12 277 U1, DE 86 15 918 U1, and US 2001/001 41 39 A1 disclose radiation generators in which the cooling liquid disposed in the protective tube housing is circulated through the protective tube housing. An external cooling device is used for cooling the cooling liquid down again. DE 88 12 277 U1 and DE 86 15 918 U1 disclose a cooling device attached to the housing.

### SUMMARY AND DESCRIPTION

The present embodiment may obviate one or more the drawbacks or limitations inherent in the related art. For example, in one embodiment, a radiation generator permits efficient and simple cooling.

In one embodiment, a radiation generator may include a protective tube housing and a radiation generating tube. The radiation generating tube may be arranged in the protective tube housing. The protective tube housing may be filled with a cooling liquid.

At least one flow channel may be integrally molded on the protective tube housing for a cooling medium ducted (channeled) via an inlet and outlet pipe and serving to cool the interior of the protective tube housing.

The radiation generator may deliver efficient cooling performance without additional devices. Because the channel is integrally molded on the protective tube housing, the protective tube housing may be manufactured more compactly and the heat produced as a result of the radiation generation may be dissipated quickly and close to the site at which it is produced. Accordingly, the flow volume and the flow rate of the cooling medium may be easily controlled. The surface area occupied by the flow channel or serving for heat exchange may be optimized. Greater scope is provided for designing the cooling surface, and at the same time the heat can be dissipated more easily and efficiently.

The flow channel for the cooling medium may be integrated into the protective tube housing. In other words, the flow channel is integrated into the protective tube housing walls. The protective tube housing serves as a cooling medium channel by being molded into an appropriate shape. For example, corrugations arching toward the interior can be provided, integrally molded in the protective tube housing wall.

The flow channel of the present invention does not serve to duct the cooling liquid that is disposed in the protective tube housing, but rather a cooling medium is ducted therein via which the protective tube housing interior is to be cooled. This is particularly effectively possible by means of the flow channels integrated into the protective tube housing.

The protective tube housing may include two housing parts, with at least one flow channel being embodied on at least one housing part. The protective tube housing may be broken into components. Accordingly, further constituent parts of the radiation generator, such as, the radiation generating tube, may be easily assembled. The protective tube housing may be divided into two housing parts, although the protective tube housing may be subdivided into more than two housing parts. The flow channel or channels may be restricted to one housing part, but they can also be routed across a plurality of housing parts.

The protective tube housing or at least the housing part of the protective tube housing having the flow channel may be a metal casting. The protective tube housing or the housing part of the protective tube housing may be easily manufactured by dead-mold casting. Using metal is necessary on account of the amount of heat that is to be expected to build up in the protective tube housing.

The radiation generator may have at least one flow channel open toward the exterior and a cover covering the same. Accordingly, the flow channel is easily accessible from outside and the manufacture of the protective tube housing having the flow channel is simplified.

The at least one flow channel may be embodied at least in sections as an annular channel which runs at least in sections around a ray exit window provided on the protective tube housing. The ray exit window may be a site where a great amount of heat builds up, so it is beneficial to cool the ray exit window. Cooling the ray exit window happens as a result of the physical proximity of the cooling medium to the ray exit window. Owing to the annular shape of the flow channel, almost the entire circumference of the ray exit window is encompassed. As a result, the heat is dissipated.

In one embodiment, at least one cooling fin may project into the flow channel. The at least one cooling fin may be integrally molded on the protective tube housing. Accordingly, the surface area of the cooled surface may be increased.

### BRIEF DESCRIPTION OF THE DRAWINGS

FIG. 1 shows a schematic representation of a radiation generator according to one embodiment,

FIG. 2 shows a schematic representation of a housing part and a flow channel according to one embodiment,

FIG. 3 shows a schematic representation of the housing part in FIG. 2,

FIG. 4 shows a schematic representation of one embodiment of a cover,

FIG. 5 shows a schematic representation of a flow channel in a another embodiment, and

FIG. 6 shows a schematic representation of two flow channels according to one embodiment.

### DETAILED DESCRIPTION

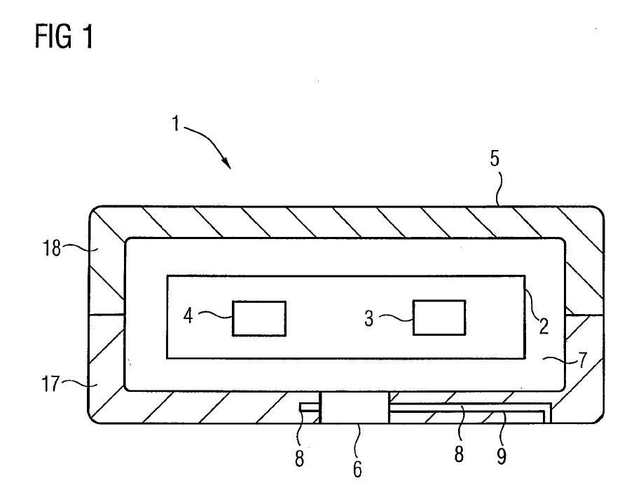

FIG. 1 shows the cross-sectional view of a radiation generator 1. The radiation generator may include a protective tube housing 5, a ray generation tube 2, and cooling liquid 7. The protective tube housing 5 may include a first housing part 17 and a second housing part 18. The first housing part 17 of the protective tube housing 5 may include a flow channel 8 through which a cooling medium 9 is ducted (channeled). The flow channel 8 is located close to the ray exit window 6 and in immediate proximity to the ray generation tube 2. The cathode 4 and the anode 3 are provided for radiation generation. Only a part of the energy expended during the radiation generation exits the protective tube housing 5 through the ray exit window 6 as X-ray radiation. The remaining energy is converted into heat. The heat may be dissipated by radiation generator 1. Inlet and outlet pipes for the cooling liquid 7 and the cooling medium 9, as well as fixtures and supply lines for the anode 3 and cathode 4 have not been shown.

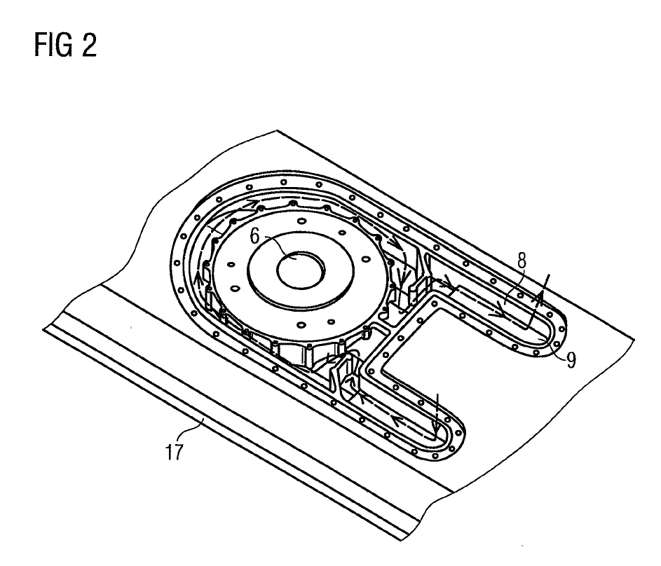

FIG. 2 shows an exterior view of the first housing part 17 of a protective tube housing 5. The flow channel 8 may be arranged in a ring shape around the ray exit window 6. The second housing part accommodates the radiation generating tube 2 and the cooling liquid 7. The first housing part 17 and the second housing part 18 form a sealed chamber after being joined together. The flow channel 8 of the first housing part 17 does, however, have to be covered again by a separate cover 12. The cover 12 is molded directly into the outer surface of the first housing part 17 or integrally molded in the first housing part 17. The housing part 17 may be a metal casting. Accordingly, the cover 12 may be integrally molded during the casting of the part. The cooling medium 9 flows into the flow channel 8 via the inlet pipe opening 13 of the cover 12, is ducted past the ray exit window 6, and flows out of the flow channel 8 again via the outlet pipe opening 14. Water or oil may be used as the cooling medium 9, although any other fluid can also be used. A connection device for the inlet and outlet pipes (e.g., quick-release couplings) may be used in the openings 13 and 14. The protective tube housing 5 is embodied as a metal casting, which means that it can also withstand the temperatures amounting to several 100° that are to be expected at the housing wall without difficulty.

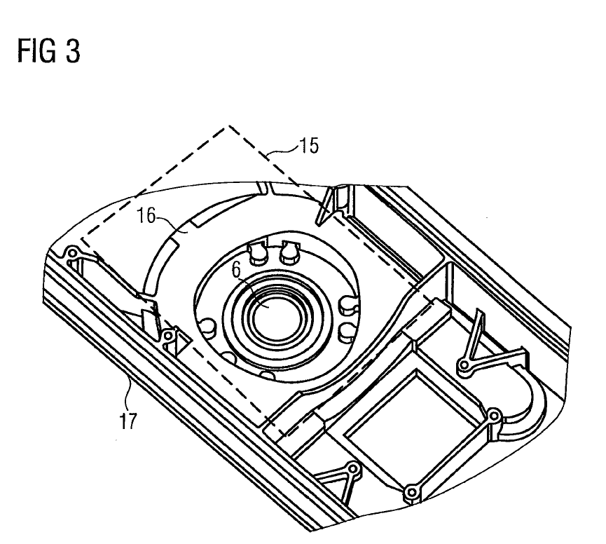

FIG. 3 shows a first housing part 17 in a view from a side facing the second housing part 18. The ray exit window 6 and the installation space 15 for the radiation generating tube 2 are also shown. The covering part 16 separates the flow channel 8 from the interior of the protective tube housing 5 including the cooling liquid 7.

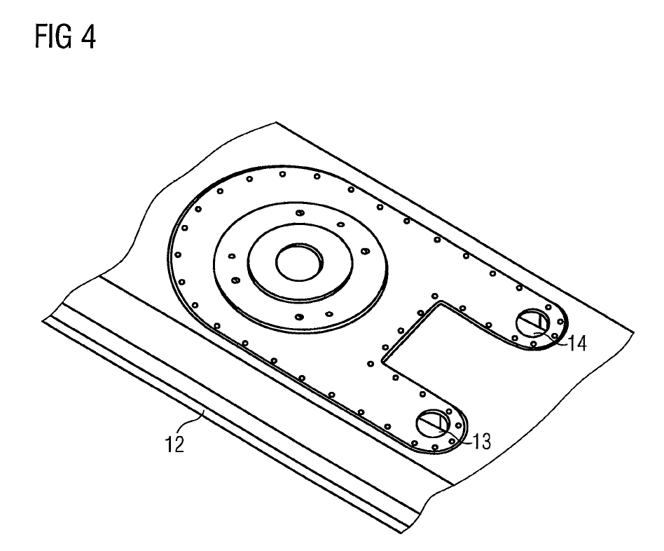

FIG. 4 shows a cover 12 matching the first housing part 17 and covering the flow channel 8 such that no cooling medium escapes from the flow channel 8. Adapters for connecting the inlet pipe and the outlet pipe may be disposed on the cover 12. The cooling medium 9 may flow through the adapters and into the flow channel 8. The inlet pipe and the outlet pipe are not fixedly connected to the cover 12, but are attached in a releasable manner. By appropriate configuration of the connection points it is possible for the inventive radiation generator to be suitable for use also with equipment that is already in service, such as X-ray devices or computed tomography scanners, and to be connectable to the already existing cooling pipes.

FIG. 5 shows a schematic representation of a flow channel 8 according to one embodiment. Cooling fins 10 and 11, which increase the size of the cooling surface, project into the flow channel. The cooling fins 10 and 11 are easy to implement during manufacture.

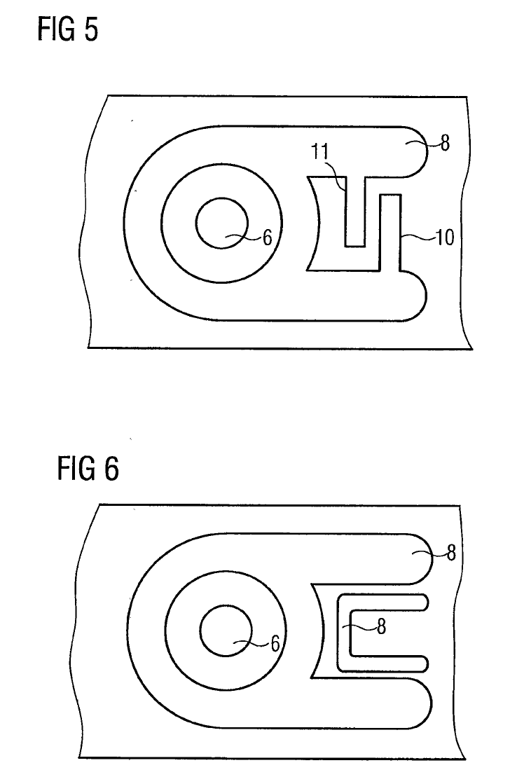

FIG. 6 shows two flow channels 8 according to another embodiment. The two flow channels 8 do not overlap. The two flow channels 8 may be used to cool a greater surface area. The second flow channel 8, a plurality of second flow channels 8, or all the flow channels 8 may be routed in a spiral shape around the protective tube housing 5.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A radiation generator comprising:
cooling liquid;
a protective tube housing filled with the cooling liquid; and
a radiation generating tube, the radiation generating tube being disposed in the protective tube housing filled with the cooling liquid,
wherein at least one flow channel is integrally molded on the protective tube housing for a cooling medium ducted via an inlet and outlet pipe and serving to cool the interior of the housing.

2. The radiation generator as claimed in claim 1, wherein the protective tube housing comprises at least two housing parts, the at least one flow channel being integrally molded on at least one of the at least two housing parts.

3. The radiation generator as claimed in claim 1, wherein the protective tube housing is embodied as a metal casting.

4. The radiation generator as claimed in claim 1, wherein at least the housing part of the protective tube housing having the flow channel is embodied as a metal casting.

5. The radiation generator as claimed in claim 1, further comprising at least one flow channel opening toward the exterior and a cover covering the at least one flow channel opening toward the exterior.

6. The radiation generator as claimed in claim 1, wherein at least one flow channel is embodied at least in sections as an annular channel which runs at least in sections around a ray exit window provided on the protective tube housing.

7. The radiation generator as claimed in claim 1, further comprising at least one cooling fin configured to project into the flow channel, the at least one cooling fin being integrally molded on the protective tube housing.

8. The radiation generator as claimed in claim 2, wherein the protective tube housing comprises at least two housing parts, the at least one flow channel being integrally molded on at least one of the at least two housing parts.

9. The radiation generator as claimed in claim 2, wherein the protective tube housing is embodied as a metal casting.

10. The radiation generator as claimed in claim 2, wherein at least the housing part of the protective tube housing having the flow channel is embodied as a metal casting.

11. The radiation generator as claimed in claim 2, further comprising at least one flow channel opening toward the exterior and a cover covering the at least one flow channel opening toward the exterior.

12. The radiation generator as claimed in claim 2, wherein at least one flow channel is embodied at least in sections as an annular channel which runs at least in sections around a ray exit window provided on the protective tube housing.

13. The radiation generator as claimed in claim 2, further comprising at least one cooling fin configured to project into the flow channel, the at least one cooling fin being integrally molded on the protective tube housing.

14. A protective tube housing for receiving a radiation generating tube for a radiation generator, the protective tube housing comprising: a first housing part having at least one flow channel, the at least one flow channel being integrally molded on the first housing part and being configured to receive a cooling medium ducted via an inlet and outlet pipe and serving to cool the interior of the housing.
